(19) United States
(12) Patent Application Publication
(10) Pub. No.: US 2014/0299100 A1
(43) Pub. Date: Oct. 9, 2014

(54) METHOD FOR CONTROLLING NATURAL GAS INJECTION IN ENGINE

(71) Applicant: ELECTRO-MOTIVE DIESEL, INC., LA GRANGE, IL (US)

(72) Inventors: MICHAEL GOETZKE, ORLAND PARK, IL (US); DEEP BANDYOPADHYAY, NAPERVILLE, IL (US); RAGHAVENDRA SUBRAMANYA, BURR RIDGE, IL (US)

(21) Appl. No.: 14/308,245

(22) Filed: Jun. 18, 2014

(51) Int. Cl. F02D 41/00

(52) U.S. Cl. CPC F02D 41/0027
USPC 123/445

(57) ABSTRACT

A method for controlling natural gas injection in a cylinder of an engine through a gas admission valve is provided. The method comprises determination of an amount of substitution, which varies between 30%-85% of a combustible mixture. Duration of injection is determined based on the amount of substitution. Based on the duration of injection, a first crank angle and a second crank angle, selected from a range of 325 degrees to 420 degrees, are determined to start and stop the injection, respectively. The natural gas is injected for the determined duration of injection, by opening the gas admission valve at the first crank angle and closing the gas admission valve at the second crank angle. The amount of substitution of the natural gas is modulated to maintain engine operating parameters at optimal. Based on the modulated duration of injection, the duration of injection for the natural gas is tuned.

### TECHNICAL FIELD

The present disclosure relates generally to natural gas injection. More specifically, the present disclosure relates to a method for controlling natural gas injection in an engine.

### BACKGROUND

Internal combustion engines, such as liquid-fuelled engines, have been used over the years to run machines. There have been improvements in the internal combustion engines to improve fuel economy, reduce emissions, and increase efficiency. For such improvements, gaseous fuels, such as methane, propane, butane, hydrogen, natural gas, and blends of such fuels, have been introduced and used. The gaseous fuels, with equivalence measured on an energy basis, may be ignited to produce the same power as that of liquid fuels, but with less harmful emissions, such as particulates and greenhouse gases.

However, the gaseous fuels do not ignite as easily as the liquid fuels. Further, the gaseous fuels may exhibit a different combustion strategy to account for longer ignition delays. Alternatively stated, a longer time may be required to inject the gaseous fuel into the internal combustion engine. In addition, the gaseous fuel supply system and the manner of introduction of the gaseous fuel into the internal combustion engine, may require an equipment specialized to handle gaseous fuels. Furthermore, a selected combustion strategy may dictate a different geometry for a combustion chamber of the internal combustion engine. Accordingly, an internal combustion engine design suitable for the liquid fuels may not be suitable for the gaseous fuels without considerable modifications, which may influence commercial viability.

### SUMMARY

The present disclosure is related to method for controlling natural gas injection in a cylinder of an engine.

According to the present disclosure, the method controls injection of natural gas in a cylinder of an engine by a gas admission valve. The method comprises determination of an amount of substitution of the natural gas to be mixed with intake air and injected through the gas admission valve. The amount of substitution of the natural gas varies between 30%-85% of a combustible mixture. Duration of injection for the natural gas is determined based on the determined amount of substitution of the natural gas. Based on the duration of injection, a first crank angle and a second crank angle are determined to start and stop the injection of the natural gas, respectively. The first crank angle and the second crank angle are selected from a range of 325 degrees to 420 degrees. The natural gas is injected through the gas admission valve for the determined duration of injection, by opening the gas admission valve at the first crank angle and closing the gas admission valve at the second crank angle. Further, the amount of substitution of the natural gas injection is modulated to maintain optimal engine operating parameters. Based on the modulated amount of substitution, the duration of injection for the natural gas is tuned.

### BRIEF DESCRIPTION OF THE DRAWINGS

FIG. 1 illustrates a schematic of an engine, in accordance with the concepts of the present disclosure;

FIG. 2 illustrates an intake manifold with a gas admission valve, in accordance with the concepts of the present disclosure;

FIG. 3 illustrates a block diagram of a control system for controlling the gas admission valve, in accordance with the concepts of the present disclosure;

FIG. 4 is a graph showing amount of substitution of the natural gas versus the crank angle of the crankshaft, in accordance with the concepts of the present disclosure; and

FIG. 5 is a flow chart illustrating a method for controlling the natural gas injection in a cylinder by use of the gas admission valve, in accordance with the concepts of the present disclosure.

### DETAILED DESCRIPTION

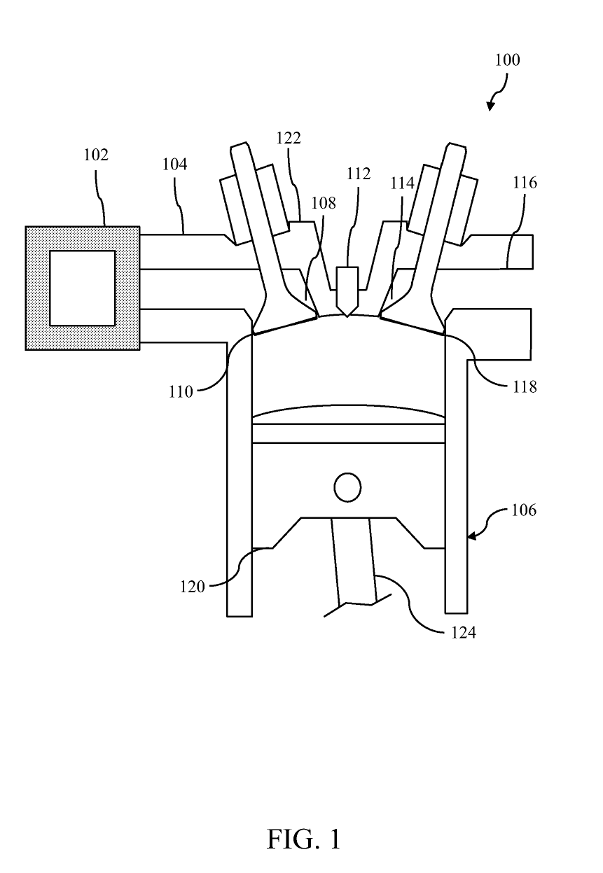

FIG. 1 illustrates a schematic of an engine 100, in accordance with the concepts of the present disclosure. The engine 100 may include an inlet manifold 102, an inlet manifold elbow 104, a cylinder 106, an intake port 108, an intake valve 110, a fuel injector 112, an exhaust port 114, an exhaust pathway 116, an exhaust valve 118, a piston 120, and a crankshaft (not shown). The engine 100 may be connected to the inlet manifold elbow 104, which in turn, is connected to the inlet manifold 102. The inlet manifold 102 may uniformly deliver air, fuel, or mixtures thereof, to the engine 100 through the inlet manifold elbow 104.

The cylinder 106 may include the intake port 108 and the exhaust port 114. The intake port 108 and the exhaust port 114 are located near a head 122 of the cylinder 106. The intake port 108 may allow entry of combustible mixture into the cylinder 106 for combustion. The entry of the combustible mixture through the intake port 108, into the cylinder 106, is controlled by the intake valve 110. The intake valve 110 may selectively deliver the combustible mixture which is supplied by the inlet manifold elbow 104. In other words, opening and closing of the intake valve 110 controls the entry of the combustible mixture into the cylinder 106 of the engine 100 for combustion.

The cylinder 106 of the engine 100 may also include the fuel injector 112, which may inject diesel fuel. Injection of the diesel fuel takes place when the combustible mixture is compressed in the cylinder. The injection of the diesel fuel in the cylinder ignites the combustible mixture and hence, the combustion produces power.

After the combustion of the combustible mixture, the exhaust gases are discharged into the exhaust port 114. The exhaust port 114 allows discharge of the exhaust gases from the cylinder 106 to the exhaust pathway 116, with the help of the exhaust valve 118. The exhaust valve 118 may selectively discharge the exhaust gases formed. In other words, the opening and closing of the exhaust valve 118 controls the discharge of the exhaust gases into the exhaust port 114. Time of opening and closing of the intake valve 110 and the exhaust valve 118 is controlled by a controller (not shown).

Further, the cylinder 106 may accommodate the piston 120, which is moveable along a length of the cylinder 106. The piston 120 moves towards and away from the head 122 of the cylinder 106, to compress and expand the combustible mixture, which enters through the intake port 108, respectively. The piston 120 is connected to a crankshaft (not shown) by use of a connecting rod 124. Longitudinal motion of the piston 120 rotates the crankshaft (not shown). When the crankshaft (not shown) rotates, the position of the crankshaft (not shown) in relation to the movement of the piston 120, in the cylinder 106, is referred to as crank angle.

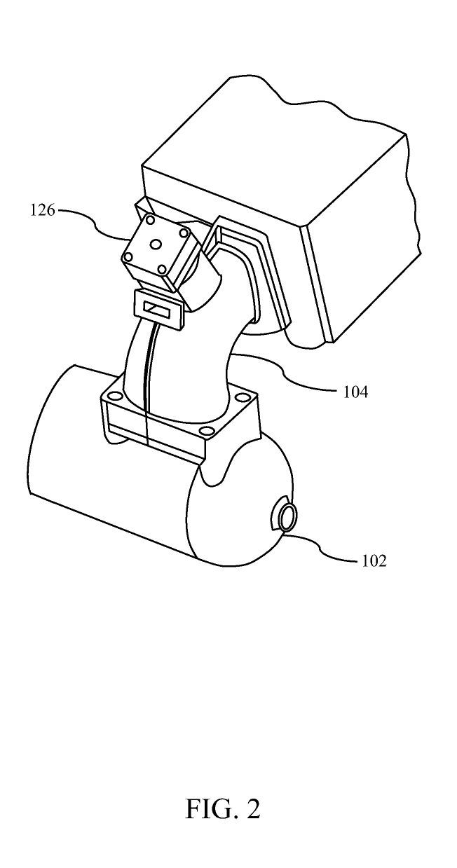

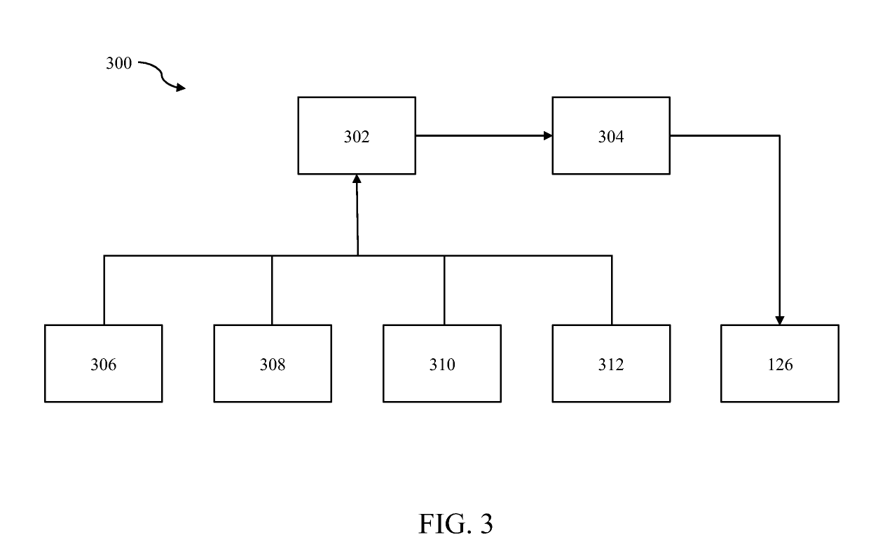

FIG. 2 illustrates the inlet manifold 102 with a gas admission valve 126, in accordance with the concepts of the present disclosure. FIG. 2 is explained in conjunction with elements from FIG. 1. As discussed in FIG. 1, and illustrated in FIG. 2, the intake manifold 102 is connected to the cylinder 106 by use of the inlet manifold elbow 104. The inlet manifold elbow 104 includes the gas admission valve 126. In an embodiment, the gas admission valve 126 is solenoid operated and controlled by a controller (as shown in FIG. 3). The gas admission valve 126 is configured to inject or deliver natural gas to the inlet manifold elbow 104. The natural gas injected by the gas admission valve 126, is mixed with air supplied through the inlet manifold 102. The combustible mixture of the air and the natural gas from the inlet manifold elbow 104 is then delivered to the intake port 108 of the cylinder 106.

FIG. 3 illustrates a block diagram of a control system 300 for controlling the gas admission valve 126, in accordance with the concepts of the present disclosure. FIG. 3 is explained in conjunction with the elements of FIG. 1 and FIG. 2. The control system 300 may include the gas admission valve 126, the controller 302, a solenoid actuator 304, a cylinder pressure sensor 306, a crankshaft position sensor 308, a knock sensor 310, and an exhaust methane sensor 312. The controller 302 may be electrically and communicatively connected to the cylinder pressure sensor 306, the crankshaft position sensor 308, the knock sensor 310, and the exhaust methane sensor 312. The controller 302 is configured to control the gas admission valve 126 by use of the solenoid actuator 304. When the controller 302 determines an amount of substitution and duration of injection of the natural gas, the controller 302 sends a signal to the solenoid actuator 304, to actuate the gas admission valve 126. In an embodiment wherein there is a plurality of gas admission valves, each of the plurality of gas admission valves is controlled by a separate controller.

The cylinder pressure sensor 306 may be positioned inside the cylinder 106. The cylinder pressure sensor 306 may measure peak cylinder pressure during the combustion. The cylinder pressure sensor 306 generates a signal having information of the peak cylinder pressure and sends the signal to the controller 302. The peak cylinder pressure may be referred to as a maximum chamber pressure achieved during the combustion.

The crankshaft position sensor 308 may be mounted on the crankshaft (not shown). The crankshaft position sensor 308 may determine a current crank angle of the crankshaft (not shown). The crankshaft position sensor 308 then sends a signal related to the current crank angle of the crankshaft (not shown), to the controller 302. The controller 302 uses the signal transmitted by the crankshaft position sensor 308, to control certain parameters, such as ignition timing and fuel injection timing.

During a combustion cycle, knocking may occur in the cylinder 106. To detect knocking, the knock sensor 310 is provided in the cylinder 106. When the knocking occurs, controller 302 receives signals generated by the knock sensor 310, in response to the knocking detected by the knock sensor 310.

Similarly, the controller 302 communicates with the exhaust methane sensor 312, which may be positioned in the exhaust pathway 116. The exhaust methane sensor 312 may detect methane that has not been burnt in the exhaust gases discharged in the exhaust pathway 116, via the exhaust port 114. The amount of the unused methane in the exhaust gases, expelled into the exhaust port 114 is referred to as methane slip. The methane slip is detected by the exhaust methane sensor 312, which helps to maintain the methane slip at or below a pre-determined value. The exhaust methane sensor 312 determines the methane slip in the exhaust gases and sends the signal to the controller 302.

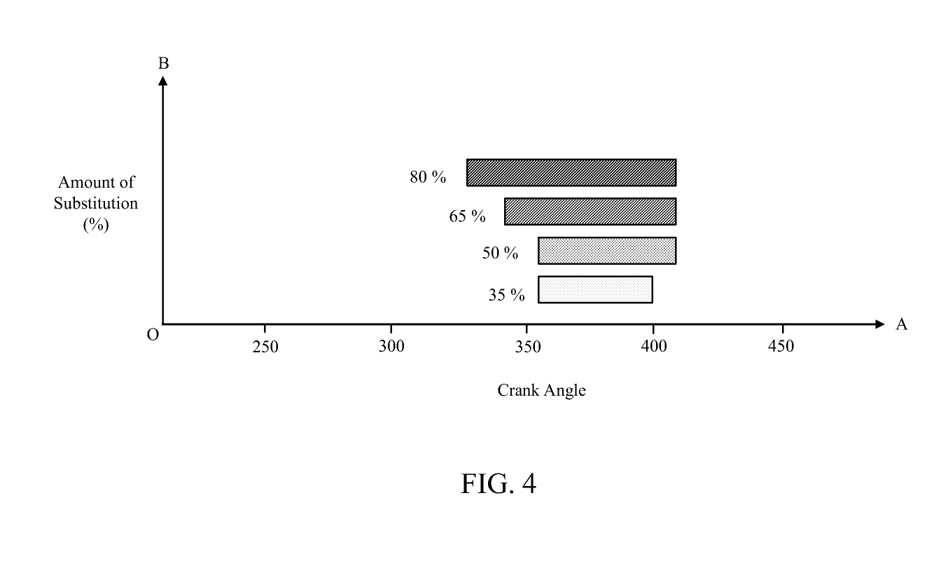

FIG. 4 is a graph showing the amount of substitution of the natural gas injection versus the crank angle of the crankshaft (not shown), in accordance with the concepts of the present disclosure. FIG. 4 is explained in conjunction with the elements of FIGS. 1-3. With reference to FIG. 4, the crank angle of the crankshaft (not shown) is shown along a horizontal axis (OA) and the amount of substitution of the natural gas (in terms of percentage of the combustible mixture) is shown along a vertical axis (OB). The graph shows that the duration of injection for low substitution of the natural gas is less. For example, when the controller 302 determines that the natural gas to be substituted is 35% of the combustible mixture, the controller 302 determines a first crank angle as 355 degrees and a second crank angle as 400 degrees. The controller 302 then sends signals to the solenoid actuator 304, to actuate the gas admission valve 126, to initiate the injection of the natural gas as the crankshaft (not shown) is at 355 degrees. As the crankshaft (not shown) rotates to the crank angle of 400 degrees, the gas admission valve 126 controls the cessation of the natural gas injection.

Similarly, if the controller 302 determines a 50% substitution of the natural gas in the combustible mixture, the natural gas injection starts at the first crank angle of 355 degrees and stops at the second crank angle of 420 degrees. At 65% substitution of the natural gas in the combustible mixture, the natural gas injection starts at the first crank angle of 340 degrees and stops at the second crank angle of 420 degrees. At 80% substitution of the natural gas in the combustible mixture, the natural gas injection starts at the first crank angle of 325 degrees and stops at the second crank angle of 420 degrees. Hence, as discussed above, the controller 302 determines that each of the first crank angle and the second crank angle are different for different amounts of substitution of the natural gas.

As discussed above, the duration of injection of the natural gas may be reduced based on certain parameters, such as the peak cylinder pressure, methane slip, rate of pressure rise in the cylinder 106, and/or knocking The information of the peak cylinder pressure may be sent to the controller 302 by the cylinder pressure sensor 306. When the controller 302 determines that the peak cylinder pressure increases above a pre-determined value, the controller 302 may reduce the duration of injection of the natural gas.

Also, the controller 302 monitors a rate of change of the pressure rise in the cylinder 106 by use of the cylinder pressure sensor 306. Hence, when the rate of pressure rise in the cylinder 106 rises above 2 M Pa/Deg, the amount of the natural gas injected through the gas admission valve 126 is reduced.

Similarly, the controller 302 receives signals from the knock sensor and the exhaust methane sensor 312. When the controller 302 receives the knock detection signal from the knock sensor 310, the controller 302 sends a signal to reduce the amount of the natural gas injection. The natural gas injection is reduced through the gas admission valve 126, by a reduced duration of injection. The controller 302 may also reduce the injection timing of the natural gas when the controller 302, by use of the exhaust methane sensor 312, determines that the methane slip is more than 10% of the total methane supplied to the cylinder 106 for combustion.

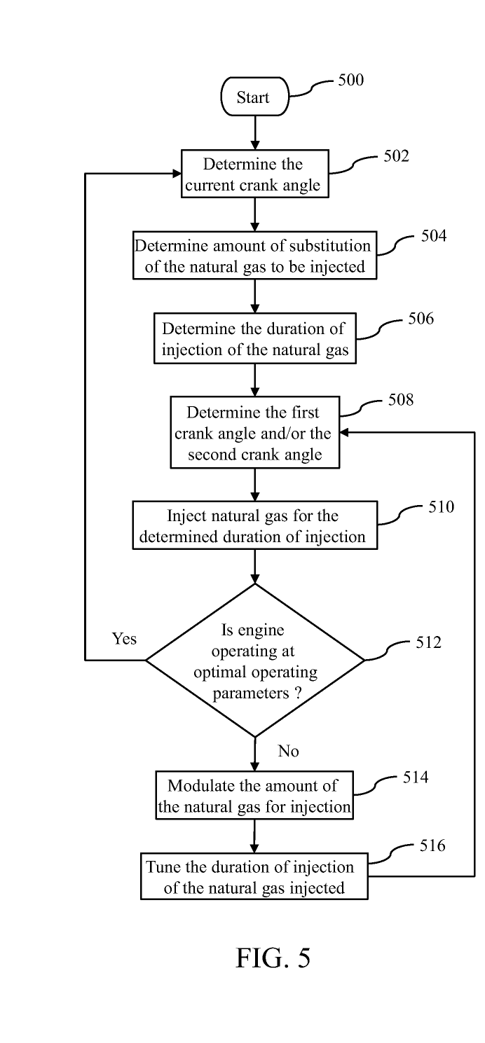

FIG. 5 is a flow chart illustrating a method for controlling the natural gas injection in the cylinder 106 by use of the gas admission valve 126, in accordance with the concepts of the present disclosure. The method begins with step 500 and proceeds to step 502.

At step 502, the current crank angle of the crankshaft (not shown) is determined by the crankshaft position sensor 308. The method proceeds to step 504.

At step 504, the controller 302 determines the amount of substitution of the natural gas to be substituted in the intake air, based on required torque, power and/or other operating parameters. During gaseous injection, the amount of substitution of the natural gas lies between 30%-85% of the combustible mixture. The method proceeds to step 506.

At step 506, the controller 302 determines the duration of injection of the natural gas on the basis of the determined amount of substitution of the natural gas. The method proceeds to step 508.

At step 508, the controller 302 determines the first crank angle to start the injection of the natural gas and the second crank angle to stop the injection of the natural gas. The first crank angle and the second crank angle are determined from a range of 325 degrees to 420 degrees. The first crank angle and the second crank angle are determined on the basis of the duration of injection of the natural gas. The method proceeds to step 510.

At step 510, the natural gas is injected through the gas admission valve 126 for the determined duration of injection by opening the gas admission valve 126 at the first crank angle and closing the gas admission valve 126 at the second crank angle. The natural gas is injected upstream of the intake valve 110. The method proceeds to step 512.

At step 512, the controller 302 determines if the engine operating parameters are optimal. The engine operating parameters may be peak cylinder pressure, knocking, the methane slip, rate of pressure rise in the cylinder 106, and/or other similar parameters. If the engine operating parameters are below the corresponding pre-determined values, the method returns to step 502. If the engine operating parameters are above the corresponding pre-determined values, the method proceeds to step 514.

At step 514, the controller 302 modulates the amount of substitution of the natural gas to be injected through the gas admission valve 126, on the basis of the output received from the cylinder pressure sensor 306, the crankshaft position sensor 308, the knock sensor 310, and the exhaust methane sensor 312. The method proceeds to step 516.

At step 516, the controller 302 tunes the duration of injection, required for injection the determined amount of the natural gas in step 516. The method then ends at step 508.

### INDUSTRIAL APPLICABILITY

The present disclosure is related to the method for controlling natural gas injection in the cylinder 106 of the engine 100, via the gas admission valve 126 disposed on the inlet manifold elbow 104.

According to the disclosed method, the controller 302 determines the current crank angle of the crankshaft. Based on torque and power requirements, the controller 302 determines the amount of substitution of the natural gas to be substituted in the intake air and injected through the gas admission valve 126. The amount of substitution of the natural gas to be injected through the gas admission valve 126 varies between 30%-85% of combustible mixture. Based on the determined amount of substitution, the controller 302 determines the duration of injection, required for injection of the determined amount of substitution of the natural gas. The controller 302 then determines the first crank angle and the second crank angle, based on the determined duration of injection for the natural gas. The first crank angle is the position of the crank shaft at which the natural gas injection starts through the gas admission valve 126. The second crank angle is the position of the crankshaft (not shown) at which the natural gas injection stops through the gas admission valve 126. Alternatively stated, the time during which the crankshaft (not shown) rotates form the first crank angle to the second crank angle is the duration of injection of the natural gas. The determined duration of injection corresponds to the determined amount of substitution of the natural gas. Further, the controller 302 may modulate the amount of substitution of the natural gas injected, to maintain engine operating parameters at optimal. On the basis of the modulated amount of substitution of the natural gas, the controller 302 tunes the duration of injection of the natural gas. Subsequently, the second crank angle is determined to stop the injection of the natural gas.

Further, the natural gas injected through the gas admission valve 126, in the inlet manifold elbow 104, is mixed with the air from the inlet manifold 102, thereby forming the combustible mixture. The combustible mixture is delivered to the cylinder 106, via the intake port 108. In the cylinder 106, the combustible mixture is compressed and ignited with by use of the diesel fuel injected by the fuel injector 112.

The disclosed method provides an improved mixing of the air and the natural gas in the inlet manifold elbow 104, prior to delivery of the combustible mixture in the cylinder 106, as compared to the existing injection methods. Also, the disclosed method aids in reducing the emissions by controlling the injection of the natural gas.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A method for controlling natural gas injection in a cylinder of an engine, with the help of a gas admission valve, the method comprising:
determining an amount of substitution of natural gas to be mixed in intake air and injected by the gas admission valve, wherein the amount of substitution of the natural gas ranges from 30% to 85%;
determining duration of injection based on the determined amount of the natural gas to be substituted;
determining a first crank angle and a second crank angle on the basis of the determined duration of injection of the natural gas; and
opening the gas admission valve at the first crank angle and closing the gas admission valve at the second crank angle, wherein the first crank angle and the second crank angle are selected from a range of 325 degrees to 420 degrees.

2. The method of claim 1, wherein the amount of substitution of the natural gas, is modulated to maintain engine operating parameters at optimal.

3. The method of claim 2, wherein on the basis of the modulated amount of substitution, the duration of injection of the natural gas through the gas admission valve is tuned.
